(19) United States
(12) Patent Application Publication
(10) Pub. No.: US 2024/0030544 A1
(43) Pub. Date: Jan. 25, 2024

(54) MITIGATING THERMAL RUNAWAY OF LITHIUM-ION BATTERIES

(71) Applicant: Canoo Technologies Inc., Torrance, CA (US)

(72) Inventors: Jongmoon Yoon, Torrance, CA (US); Yuhang Chen, Torrance, CA (US); Oscar Francisco Cervantes Huacuja, Torrance, CA (US)

(21) Appl. No.: 17/814,204

(22) Filed: Jul. 21, 2022

(51) Int. Cl. H01M 50/30; H01M 10/658; H01M 50/209; H01M 50/213

(52) U.S. Cl. CPC H01M 50/30; H01M 10/658; H01M 50/209; H01M 50/213; H01M 2220/20

(57) ABSTRACT

A battery system includes a cover including a plurality of guide apertures. The battery system also includes a thermal barrier disposed adjacent the plurality of guide apertures of the cover. Each one of the plurality of guide apertures is configured to guide emissions through the cover, and the thermal barrier is configured to absorb heat energy generated by the emissions. The battery system may further include a plurality of battery cells, and the thermal barrier may be disposed between the plurality of battery cells and the cover. Each one of the plurality of battery cells may include a vent configured to release the emissions. Each of the plurality of guide apertures of the cover may be aligned with the vent of one of the plurality of battery cells to guide emissions released by the vent through the cover.

### TECHNICAL FIELD

This disclosure relates generally to electrical batteries. More specifically, this disclosure relates to mitigating thermal runaway of lithium-ion batteries.

### BACKGROUND

Lithium (Li)-ion rechargeable battery cells have an intrinsic drawback of catching fire from organic solvents, highly unstable plated Li-metal, or exothermic reactions of cathode active material, which are core components of current Li-ion rechargeable battery cell systems. Due to the intrinsic technical advantage in volumetric and gravimetric energy density, Li-ion rechargeable cells are promising battery systems for electric vehicles and other energy storage systems. Therefore, in current energy storage systems, mitigating, retarding, or stopping fire propagation is critical for Li-ion rechargeable battery systems. To avoid and prevent propagating fire between cells, various approaches have been attempted, such as mechanical protection, liquid immersion, applying fire retarding material, using a built-in extinguisher, etc. However, these approaches require additional costs and volume. Thus, implementing these approaches with a Li-ion battery system is typically not feasible given the constrained volume for automotive vehicles, bikes, airplanes, etc.

### SUMMARY

In one example embodiment, a battery system includes a cover including a plurality of guide apertures. The battery system also includes a thermal barrier disposed adjacent the plurality of guide apertures of the cover. Each one of the plurality of guide apertures is configured to guide emissions through the cover, and the thermal barrier is configured to absorb heat energy generated by the emissions.

In some embodiments, the battery system further includes a plurality of battery cells, and the thermal barrier is disposed between the plurality of battery cells and the cover.

In some embodiments, each one of the plurality of battery cells includes a vent configured to release the emissions.

In some embodiments, each of the plurality of guide apertures of the cover is aligned with the vent of one of the plurality of battery cells to guide emissions released by the vent through the cover.

In some embodiments, the battery system further includes a housing, the plurality of battery cells is arranged within the housing, and the cover is coupled to the housing.

In some embodiments, the cover includes side plates each coupled to the housing, the side plates each include a portion of the plurality of guide apertures, and the thermal barrier includes two thermal barriers each disposed adjacent to one of the side plates.

In some embodiments, the plurality of battery cells is a plurality of cylindrical battery cells.

In some embodiments, the plurality of battery cells is a plurality of prismatic battery cells.

In some embodiments, the vent is configured to open in response to pressure reaching a preset threshold level.

In some embodiments, the thermal barrier has a tensile strength below 150 kPa.

In another example embodiment, an electric vehicle includes at least one electric motor. The electric vehicle also includes a power supply configured to provide electrical energy to the at least one electric motor. The power supply includes a battery module. The battery module includes a cover including a plurality of guide apertures. The battery module also includes a thermal barrier disposed adjacent the plurality of guide apertures of the cover. Each one of the plurality of guide apertures is configured to guide emissions through the cover, and the thermal barrier is configured to absorb heat energy generated by the emissions.

In some embodiments, the battery module further includes a plurality of battery cells, and the thermal barrier is disposed between the plurality of battery cells and the cover.

In some embodiments, each one of the plurality of battery cells includes a vent configured to release the emissions.

In some embodiments, each of the plurality of guide apertures of the cover is aligned with the vent of one of the plurality of battery cells to guide emissions released by the vent through the cover.

In some embodiments, the battery module further includes a housing, the plurality of battery cells is arranged within the housing, and the cover is coupled to the housing.

In some embodiments, the cover includes side plates each coupled to the housing, the side plates each include a portion of the plurality of guide apertures, and the thermal barrier includes two thermal barriers each disposed adjacent to one of the side plates.

In some embodiments, the plurality of battery cells is a plurality of cylindrical battery cells.

In some embodiments, the plurality of battery cells is a plurality of prismatic battery cells.

In some embodiments, the vent is configured to open in response to pressure reaching a preset threshold level.

In some embodiments, the thermal barrier has a tensile strength below 150 kPa.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example electric vehicle including a battery module storage location in accordance with embodiments of this disclosure;

FIGS. 2A-2C illustrate an example vehicle framework and an example battery enclosure in accordance with embodiments of this disclosure;

FIGS. 3A-3D illustrate an example battery module in accordance with embodiments of this disclosure;

FIG. 3E illustrates an example protective cover of a battery module in accordance with embodiments of this disclosure;

FIGS. 4A-4C illustrate an example protective cover in accordance with embodiments of this disclosure;

FIG. 4D illustrates an example thermal barrier in accordance with embodiments of this disclosure;

FIGS. 5A-5F illustrate additional details of an example battery module in accordance with embodiments of this disclosure;

FIG. 6 illustrates an example battery module having a cover with mounting holes in accordance with embodiments of this disclosure;

FIG. 7 illustrates an example chart showing temperatures of a battery cell experiencing thermal runaway and temperatures of surrounding cells, where a battery module includes a rigid thermal barrier and/or where the battery module does not have a cover with apertures aligned with cell vents; and

FIG. 8 illustrates an example chart showing temperatures of a battery cell experiencing thermal runaway, and temperatures of surrounding cells, where a battery module includes a soft thermal barrier and includes a cover with apertures aligned with cell vents in accordance with embodiments of this disclosure.

### DETAILED DESCRIPTION

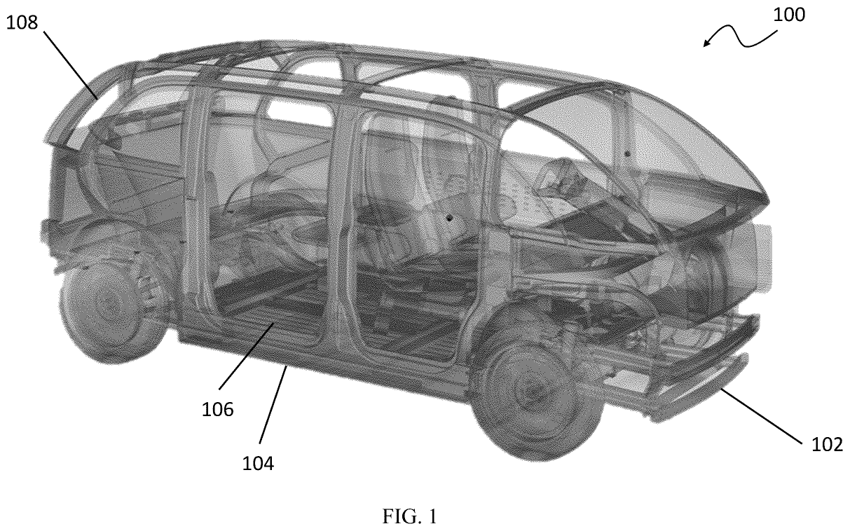

FIGS. 1 through 8, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

Various embodiments of this disclosure include a battery system for an electric vehicle or other powered device or system. The battery system includes a plurality of components, such as a plurality of battery cells with a thermal barrier and a protective cover that are coupled such that they form a battery module that makes up at least a portion of a power source. In various embodiments, battery modules are stored in an enclosure that makes up a portion of an electric vehicle framework and provides structural support to both the electric vehicle and the various components of a skateboard structure, as well as support mechanisms for individual battery modules within the structure.

This disclosure provides a battery system or module that includes a thermal insulation barrier disposed around a portion of the battery cells of the battery system and a cover including a plurality of apertures aligned with locations of cell vents of the battery system. The battery system of this disclosure is extremely effective to prevent and/or mitigate fire propagation from a cell experiencing thermal runaway, and the battery system is compact and conveniently allows for the use of Li-ion rechargeable cells in constrained spaces (such as in electric automotive vehicles) while alleviating and preventing thermal runaway and fire propagation issues.

The development of electric vehicles brings with it new challenges, including the storage and protection of the power source that serves to provide power to the propulsion system of the electric vehicle. Typically, electric vehicle manufactures design a framework for the vehicle to support all of the functional elements of the vehicle. Many such frameworks are designed to support the propulsion system as well as mechanical and electrical linkages between the propulsion system and other components and systems of the vehicle. Included within the framework of many vehicles is a location to store a power supply having one or more battery modules, which is typically used to provide the main power to the various components of the vehicle including the propulsion system. Many vehicle designs incorporate a battery storage area in the bottom of the vehicle due to the weight of the batteries, thus keeping the center of gravity as low as possible. Additionally, monolithic pre-sealed batteries can be inserted into an interior space within the framework of the vehicle. The pre-sealed batteries add a layer of protection around the batteries to prevent leakage or damage. An example vehicle framework is disclosed in U.S. Pat. No. 11,251,494, which is hereby incorporated by reference in its entirety.

FIG. 1 illustrates an example electric vehicle 100 including a battery module storage location in accordance with embodiments of this disclosure. The electric vehicle 100 includes a framework 102 on which various components are positioned. In various embodiments, the electric vehicle 100 includes a power supply (such as one or more battery modules) that provides electrical power to one or more electric motors and other components of the electric vehicle 100. The electric vehicle 100 further includes a battery enclosure 104 that may be positioned in or near the center of the electric vehicle 100, which is designed to house one or more battery components 106. The positioning can help to stabilize the vehicle 100 by ultimately lowering its center of gravity. Many embodiments of an electric vehicle framework 102 can also provide attachment points for an upper portion or top hat 108 of the electric vehicle 100 that may have its own separate frame structure to support the overall body of the vehicle 100.

The electric vehicle 100 can, in various embodiments, include a battery enclosure to provide additional structural elements that act to strengthen the overall framework 102 of the vehicle 100, as well as support other functional components of the vehicle 100. In part, this also allows for a more modular design with respect to the battery compartment. Having multiple sections of the overall battery compartment can allow for the use of numerous individual battery modules to be housed within the compartment. The modularity can be advantageous in that maintenance costs can be reduced by not requiring the entire power supply or monolithic pre-sealed battery to be replaced, but rather individual modules can be replaced and/or repaired as needed. Additionally, maintaining a sealed enclosure or one that is protected from the outside environment can be useful or important to electric vehicle power sources. Accordingly, some embodiments may incorporate top and bottom plates that can ultimately act to seal the entire battery compartment as well as provide additional protection for outside intrusion or exposure.

Although FIG. 1 illustrates one example of an electric vehicle 100, those skilled in the art will recognize that the full structure and operation of a suitable vehicle are not depicted in the drawings or described here. Instead, for simplicity and clarity, only the structure and operation necessary for an understanding this disclosure is depicted and described. Various changes may be made to the example of FIG. 1, and improved battery modules to mitigate thermal runaway described in this disclosure may be used with any other suitable vehicle or any other suitable powered device or system.

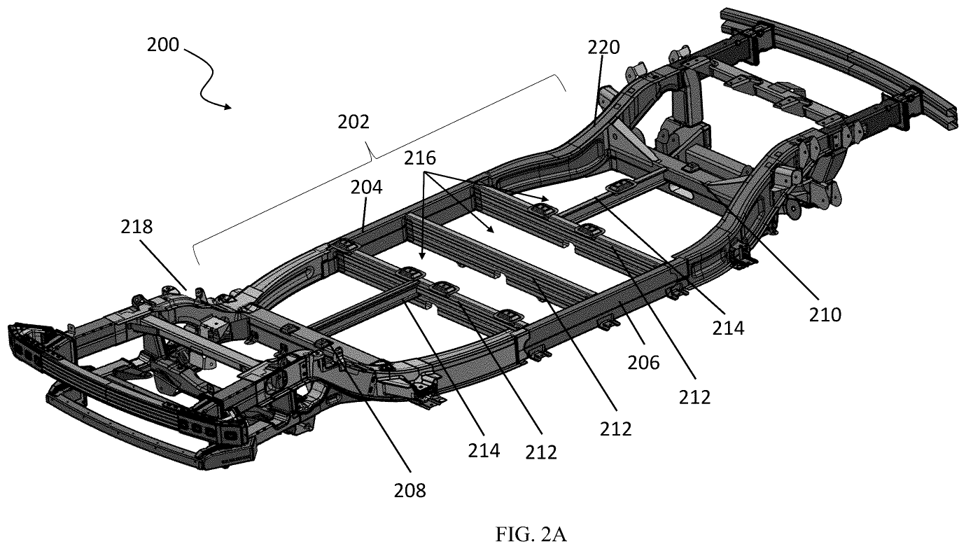

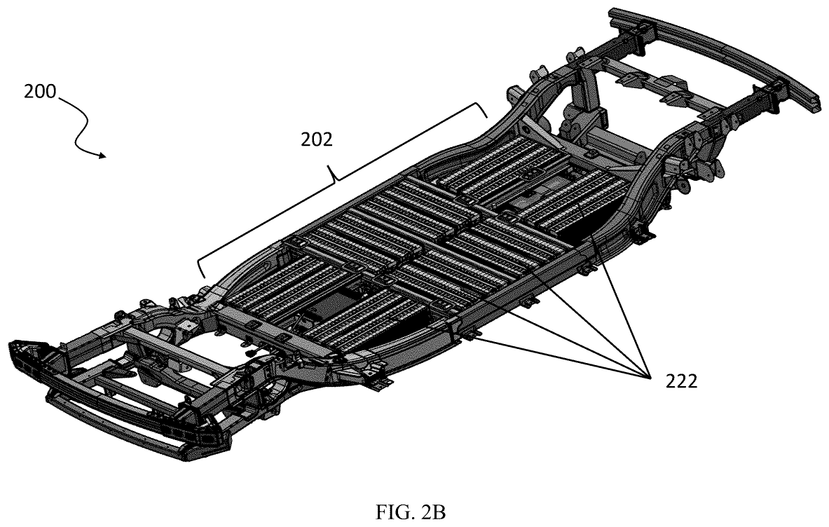

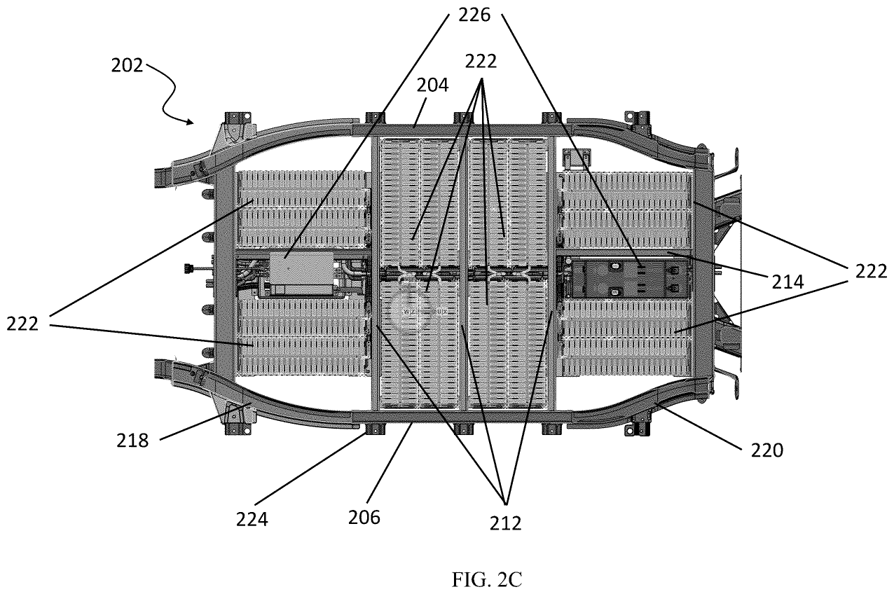

FIGS. 2A-2C illustrate an example vehicle framework 200 and an example battery enclosure 202 in accordance with embodiments of this disclosure. In some embodiments, the vehicle framework 200 can incorporate the battery enclosure 202 within an open mid-section of the vehicle framework 200. For example, FIGS. 2A and 2B illustrate embodiments of the vehicle framework 200 with a forward end and a rear end. A center section represents what may be considered the battery enclosure 202. The vehicle framework 200 can include various components, such as side rails 204 and 206 and forward and rear cross members 208 and 210, to make up the exterior walls or framework of the battery enclosure 202. The framework 200 can also include additional components that subdivide the interior space of the mid-body or battery enclosure 202 into a number of separated interior spaces. For instance, the battery enclosure 202 may contain additional cross members 212 that transverse the width of the framework. Such cross members can act to add additional strength (twisting, bending, and impact) to the framework of the vehicle 100 and provide additional structural support for the battery modules. The cross members 212 may also serve to provide structural support and connection points for additional elements within the body of the vehicle, such as seating elements and/or upper body components.

In various embodiments, the battery enclosure 202 may also have longitudinal support members 214 that may be connected between the forward and rear cross members 208 and 210 and a transverse cross member 212 of the battery enclosure 202. Similar to the transverse cross members 212, the longitudinal support members 214 may serve to add structural support to the framework 200 as well as battery modules 222 as illustrated in FIGS. 2B and 2C.

The structural elements of the battery enclosure 202 may define one or more spaces 216 that can serve as areas to place battery modules. Additionally, the longitudinal and traverse cross members 214 and 212 may be configured with one or more openings that traverse the width of the various cross members. The openings, in many embodiments, may be used to run interconnection components between the various battery modules and/or auxiliary elements. Although certain configurations of structural elements are shown, it should be understood that any number and arrangement of such structural members might be implemented such that sufficient frame stability is created. In addition to conferring additional stability to the vehicle platform, such interior structural members also provide support elements for one or more of the battery modules 222 and/or support components 224 disposed within the frame battery compartment and for vehicle body elements mounted to the vehicle platform.

Since the battery enclosure 202 may serve as a multi-function component of the overall vehicle 100, many embodiments may incorporate unique features and elements within the battery enclosure framework to improve the overall function of the framework and electric vehicle 100. For example, many embodiments of the side rails 204 and 206 may have additional forward and rear frame rails 218 and 220. The frame rails 218 and 220 may serve as additional support elements for the vehicle components. However, in many embodiments, the frame rails 218 and 220 may also serve as extensions of the side rails 204 and 206 that make up the sides of the battery enclosure 202. Additionally, some embodiments may incorporate impact control elements to help prevent potential penetration into the energy storage compartment.

Energy storage systems that have modular battery components may be designed with various structural and functional features to aid in the simplicity of design, use, and overall adaptability of the electric vehicle platform. For example, some embodiments may be adaptable to different power requirements that may involve more or fewer battery modules. Thus, modularity of components can be beneficial in the overall function of the vehicle platform. In some embodiments, such as the one shown in FIG. 2C, the vehicle framework 200 incorporates an electric vehicle battery system or energy storage system that includes a number of separate modular vehicle battery elements 222 interconnected together and with the other elements of the vehicle platform through a suitable configuration of wires and/or buses, as well as battery support systems 226 (such as cooling, battery disconnects, and power management components). These modular vehicle battery elements 222 are disposed within the mid-body space 216 of the framework 200 such that the structural elements of the framework 200 combine to directly form the sealed battery containment vessel for the vehicle battery elements. By using elements of the framework 200 as the containment vessel for the energy storage system, substantial weight savings can be realized in accordance with some embodiments.

Although FIGS. 2A-2C illustrate one example of a vehicle framework 200 and one example of a battery enclosure 202, those skilled in the art will recognize that the full structure and operation of a suitable vehicle framework and battery enclosure are not depicted in the drawings or described here. Instead, for simplicity and clarity, only the structure and operation necessary for an understanding this disclosure is depicted and described. Various changes may be made to the examples of FIGS. 2A-2C, such as positioning the battery enclosures at other locations of the framework 200 or of the electric vehicle 100. Also, the improved battery modules designed to mitigate thermal runaway described in this disclosure may be used with any other suitable vehicle framework or other structure.

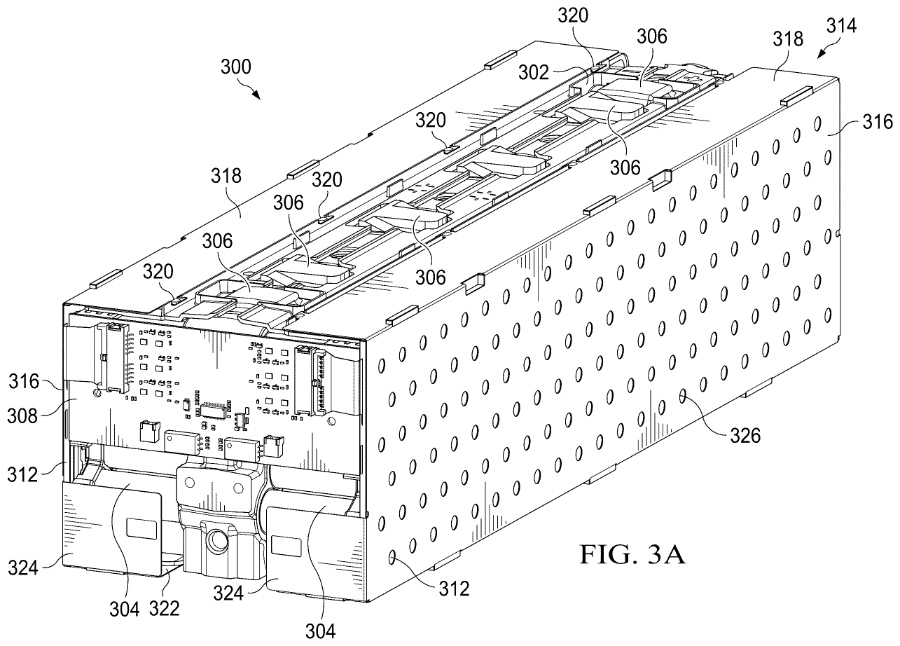

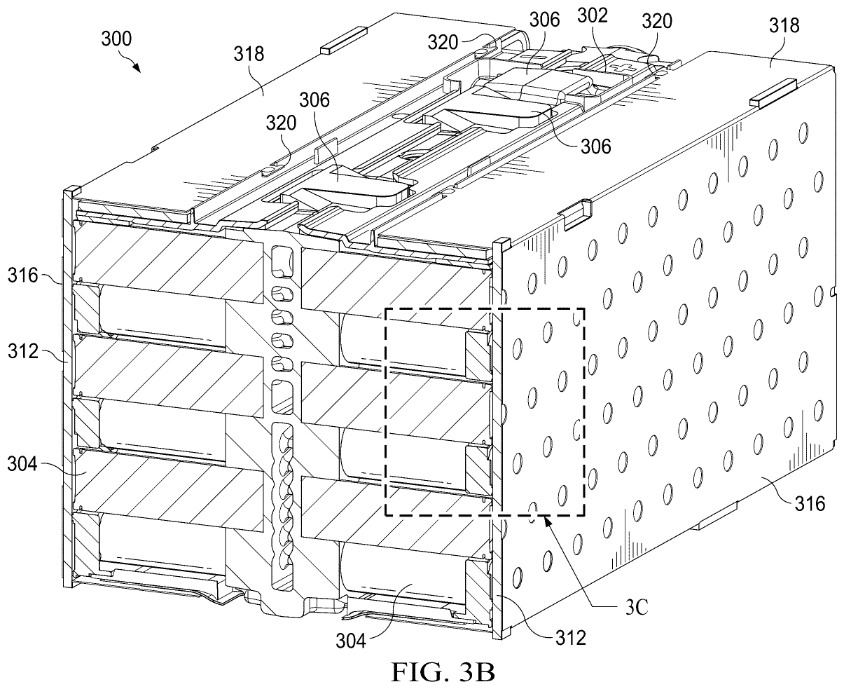

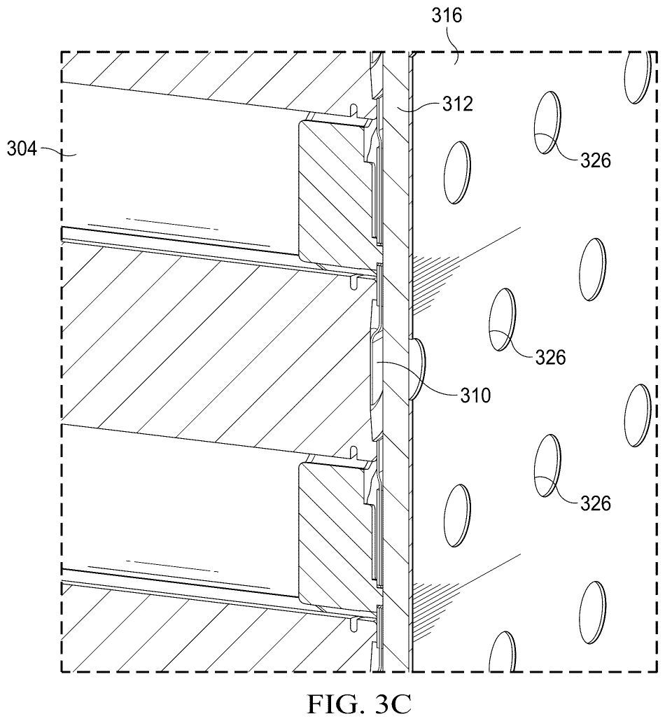

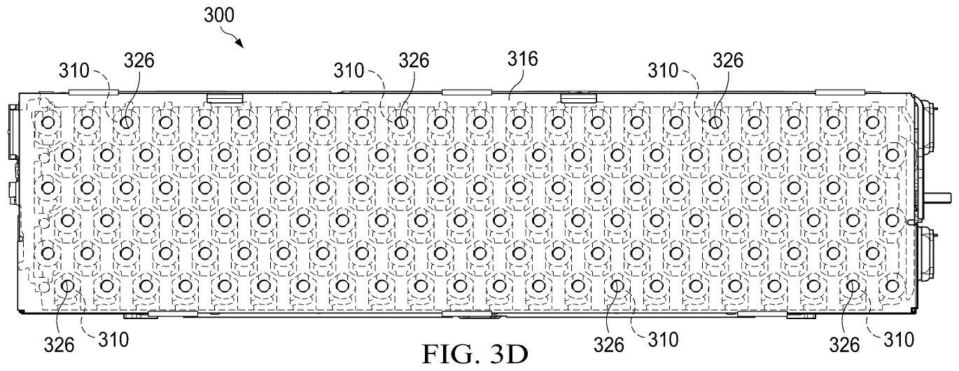

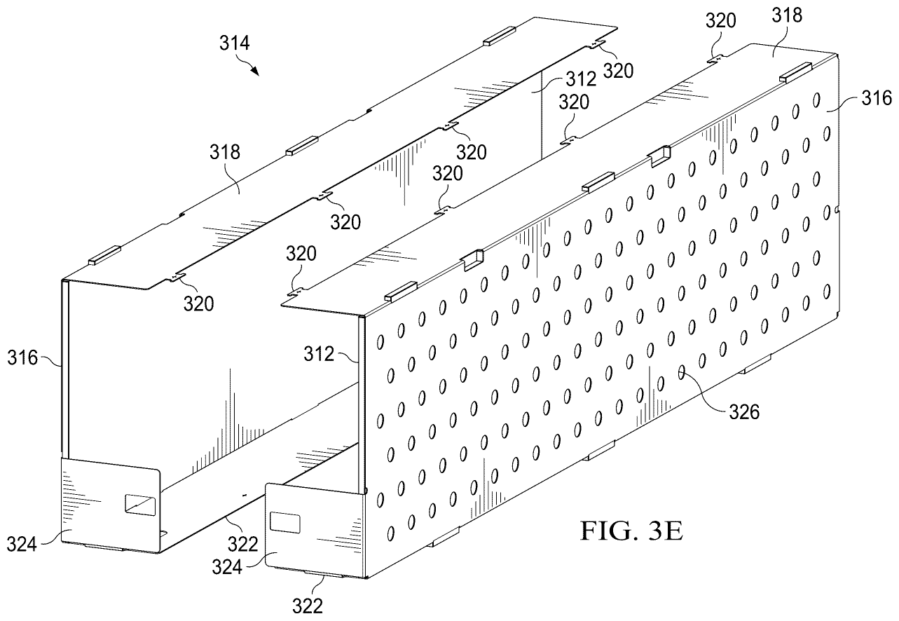

FIGS. 3A-3D illustrate an example battery module 300 in accordance with embodiments of this disclosure. More specifically, FIG. 3A illustrates the battery module 300 fully assembled, FIG. 3B illustrates a cross-sectional view of the battery module 300 showing an internal portion of the battery module 300, FIG. 3C illustrates an enlarged view of a portion of the internal portion of the battery module 300 shown in FIG. 3B, and FIG. 3D illustrates a side view of the battery module 300.

As shown in FIGS. 3A-3D, the battery module 300 includes a housing 302 that holds a plurality of lithium-ion battery cells 304, such as via a shelving system. The housing 302 encloses the battery cells 304 and, in various embodiments, is sealed by a retaining or interlocking mechanism 306, such as buckles, clasps, bolts, or other types of hardware. The battery cells 304, as illustrated in FIGS. 3A-3D, can be cylindrical battery cells electrically coupled within the housing 302 to serve as at least a portion of a power source to an electric vehicle, such as electric vehicle 100, or other powered device or system. In some embodiments, the battery module 300 can be installed within a framework for the electric vehicle 100, such as the framework 200.

The battery module 300 further includes a circuit board 308 that can include various components such as one or more processors, sensors, power source connections, etc. The circuit board 308 facilitates various functions of voltage and temperature sensing for diagnostics, cell-to-cell balancing, discharge-power, battery cooling and charging control, and/or alert condition monitoring, such as overcharging, over-discharging, monitoring temperature and thermal runaway. In various embodiments of this disclosure, each battery cell 304 includes a vent 310 having a vent cap to allow for gas or burst fire emissions to exit the battery cell 304 when pressure within the battery cell 304 reaches a preset threshold level. In some embodiments, the vent 310 can include a cap that is destroyed by gases or burst fire exiting the battery cell 304 through the vent 310 upon pressure reaching the pressure threshold. In other embodiments, the cap can mechanically open and close, such as by using a vent valve, when pressure reaches the preset threshold level.

In lithium-ion battery cells, gas that accumulates inside the battery cell is typically generated by the gasification of carbonate solvents and side reactions. The internal pressure of the battery cell will increase when the temperature exceeds the boiling point of any of the components in the solvents. Vaporized solvents can thus erupt and be exhausted from a pouch cell, usually without a vent valve, once the internal pressure increases. A hard case cell with a vent valve can hold for a time until the inner pressure exceeds the opening pressure. Therefore, the rupture temperature for the pouch cells will be near the boiling point of the carbonate that vaporizes first, whereas the rupture temperature for hard-case cells is typically higher. During thermal runaway, the battery cell swells before gas is exhausted. Thermal runaway generates a large amount of heat, and it is the temperature rise that stimulates the rupture of the cell while sparks generated during high-speed venting ignite the flammable gases. Explosive burst fire emission also causes fire propagation to other battery cells. Additionally, due to the extreme heat of an explosive burst fire emission during thermal runaway, the vent cap can still be damaged even if venting of the explosive burst fire emission successfully prevents fire propagation.

Existing techniques for mitigating or retarding fire propagation from cell thermal runaway focus on using a high thermal resistance barrier including intumescent characteristics or a coating that is applied to cover cells to minimize heat conduction or radiation from thermal runaway cells and to absorb heat energy of thermal runaway cells via endothermic reactions from a phase-change transition. However, these techniques are only based on blocking heat energy or fire or absorbing heat energy injection from thermal runaway fire. Also, these techniques do not identify which specific area and location to protect thermally from thermal runaway fire in terms of explosive burst fire direction. Moreover, these techniques do not adequately handle explosive burst fire from rigid packaged cells, which can be a critical source of heat energy that causes fire propagation to surrounding cells.

To prevent or mitigate fire propagation, various embodiments of this disclosure include a thermal insulation barrier around the battery cells in a battery module to protect the cells from thermal runaway, as well as a protective cover to hold the thermal barrier in the correct position. As illustrated in FIGS. 3A-3D and also referring to FIG. 3E, which illustrates an example protective cover 314 of the battery module 300 in accordance with embodiments of this disclosure, the battery module 300 includes thermal barriers 312 disposed in, coupled to, or adhered within an interior portion of the protective cover 314. In some embodiments, such as the one illustrated in FIGS. 3A-3D and FIG. 3E, the cover 314 can include two side plates 316 having a first exterior side and a second interior side. The thermal barriers 312 are disposed, coupled, or adhered adjacent the second interior side of each side plate 316, such as is illustrated in FIG. 3D and FIG. 3E. The side plates 316 can additionally include upper plates 318 that extend over a top portion of the housing 302 of the battery module 300 and can be secured to the housing 302, such as via brackets 320 that extend over and press against a surface of the housing 302 or via other securing or fastening hardware. The side plates 316 can additionally include lower plates 322 that cover a bottom portion of the housing 302, as well as front plates 324 that cover a portion of a front of the battery module 300. The various plates 316, 322, 324 thus serve to surround and protect the battery cells 304.

The cover 314 can be made from various materials, such as plastic materials like plastic resin, plastic resin matrix reinforced by glass or carbon fiber or metallic materials like aluminum or steel or plastic-film coated metal or plastic resin molded metal metallic. Lithium-ion rechargeable cells have a rigid packaging, such as metal packaging or fiber-reinforced plastic resin wrapped metal packaging. Lithium-ion rechargeable cells in such a rigid packaging, including designated vents, exhibit explosive burst fire as a first step of fire energy release from cell internal thermal runaway. To mitigate, prevent, and stop fire propagation from highly heating up and thermally damaging surrounding battery cells, it is often necessary or desirable to thermally isolate explosive burst fire quickly (such as at or near the beginning of a thermal runaway event) by guiding the explosive burst fire out of the battery module without the explosive burst fire continuing long enough to heat surrounding cells near the cell experiencing thermal runaway.

In this example, the cover 314 further includes a plurality of holes or apertures 326 disposed through the side plates 316. The apertures 326 are aligned with the vents 310 of the battery cells 304 in order to guide explosive burst fire emitted from the vents 310 through the apertures 326 and away from other battery cells 304. The apertures 326 allow for emissions to be guided out and away from the battery module quickly when thermal runaway occurs, without allowing the emissions to remain long enough to heat up surrounding cells 304. This, combined with the thermal barriers 312 insulating the battery cells 304 and absorbing heat energy during thermal runaway and during an explosive burst fire event, mitigates the thermal runaway experienced by a battery cell 304 and prevents fire propagation to other battery cells 304.

The thermal barriers 312 can be made of one or more materials with enough thermal resistance to mitigate and stop fire propagation, as well as insulate the sensitive cell vents 310, which are usually a mechanical weak point and a thin package material that could be easily melted and damaged from explosive burst fire. In some embodiments, the thermal barriers 312 can have a thermal conductivity from about 0.05 W/m*K to about 0.2 W/m*K. In addition, the thermal barriers 312 ideally will not melt from explosive burst fire from cell thermal runaway in order to provide thermal insulation for and protect surrounding cells 304. In some embodiments, the thermal barriers 312 can have a melting point above about 800° C. In various embodiments, the thermal barriers 312 are soft and/or porous thermal barriers to facilitate air flow, have a mechanical tensile strength below about 150 kPa, and are made from materials such as ceramic wool or fabric (which may be formed using silicon oxide, calcium oxide, ceramic powder, glass wool, etc.) that provide high levels of thermal resistance to prevent thermal damage to cells 304 without melting from fire caused by cell thermal runaway.

Strong and rigid thermal barriers, such as high mechanical strength ceramic or glass wool or fabric, ceramic plate barriers, rock wool barriers, etc., can block explosive burst fire from being emitted quickly through the apertures 326, holding the explosive burst fire within the cover 314 and potentially damaging cells 304 and allowing fire propagation. The thermal barrier 312 can be of varying thickness, where its thickness may vary depending on the amount of space between the battery cells 304 and the cover 314. In some cases, the thermal barrier 312 may have a nominal thickness of about 3 mm. The variations in the thickness of the thermal barrier 312 can vary depending on various factors, such as the material of the thermal barriers 312 and/or the energy absorption needed by the thermal barriers 312.

Although FIGS. 3A-3D illustrate one example of a battery module 300 and FIG. 3E illustrates one example of a protective cover 314, those skilled in the art will recognize that various changes may be made to the examples of FIGS. 3A-3D and FIG. 3E. For example, the cover 314 may be a singular component, rather than two separate components, formed or shaped to at least partially enclose or surround the battery module 300. Additionally, the overall structure of the battery module 300, the thermal barrier 312, and/or the cover 314 may differ without departing from the scope of this disclosure, such as by altering the dimensions of the battery module 300, the thermal barrier 312, and/or the cover 314, the arrangement of the apertures 326 so as to align with vents 310, the number of battery cells, the arrangement of the battery cells, and so on.

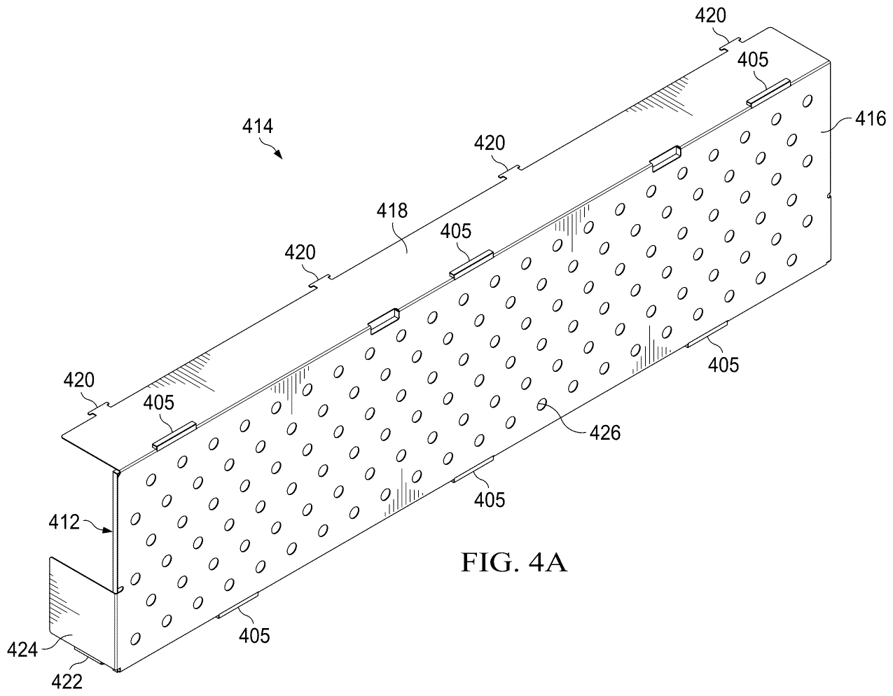

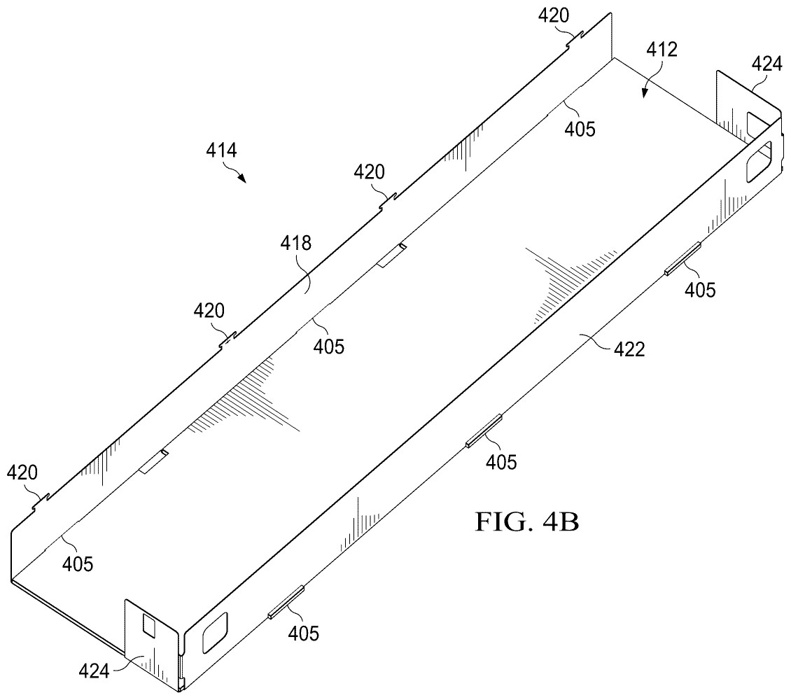

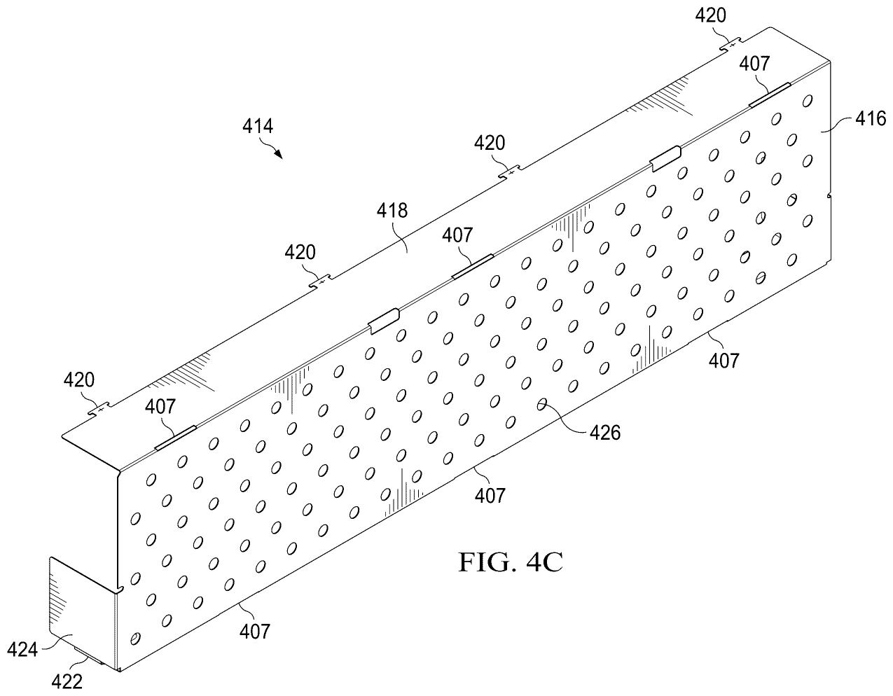

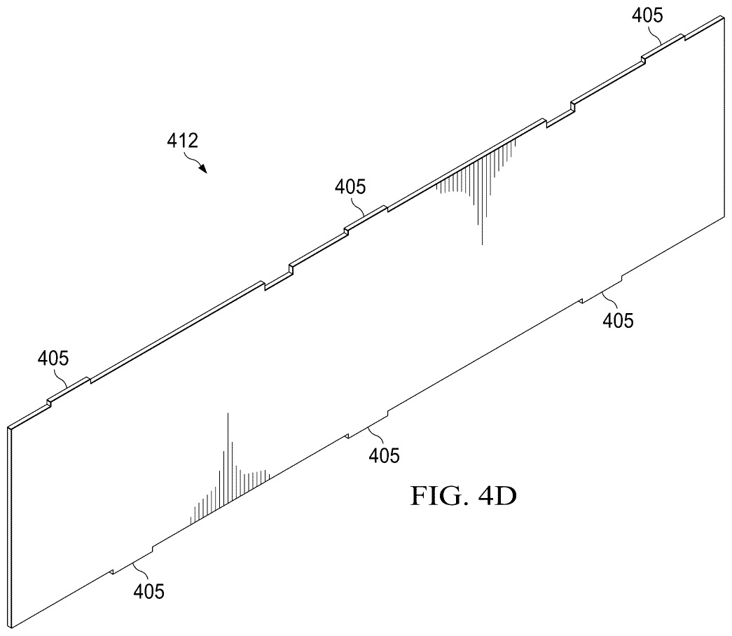

FIGS. 4A-4C illustrate an example protective cover 414 in accordance with embodiments of this disclosure and FIG. 4D illustrates an example thermal barrier 412 in accordance with embodiments of this disclosure. It will be understood that the protective cover 414 illustrated in FIGS. 4A-4C can be one half of a full protective cover that covers a battery module, with the other half of the full protective cover mirroring the components of the protective cover 414, such as shown and described in FIGS. 3A-3D.

The cover 414 includes side plate 416 having a first exterior side and a second interior side. The example protective cover 414 includes a thermal barrier 412 disposed on the second interior side. In this example, the thermal barrier 412 includes extruded tabs 405 located at various positions along top and bottom edges of the thermal barrier 412. The extruded tabs 412 securely fit within cutouts 407 of the cover 414 to mechanically couple the thermal barrier 412 to the cover 414 on the second interior side of the cover 414.

The side plate 416 can additionally include an upper plate 418 that extends over a top portion of a battery module, such as battery module 300, and can be secured to a housing of the battery module, such as housing 302, such as via brackets 420 that extend over and press against a surface of the housing or via other securing or fastening hardware. The side plate 416 can additionally include a lower plate 422 that covers a bottom portion of the housing of a battery module, as well as a front plate 424 that covers a portion of a front of a battery module. The various plates 416, 422, 424 thus serve to surround and protect battery cells of a battery module.

The cover 414 can be made from various materials, such as plastic materials like plastic resin, plastic resin matrix reinforced by glass or carbon fiber or metallic materials like aluminum or steel or plastic-film coated metal or plastic resin molded metal metallic. Lithium-ion rechargeable cells have a rigid packaging, such as metal packaging or fiber-reinforced plastic resin wrapped metal packaging. Lithium-ion rechargeable cells in such a rigid packaging, including designated vents, exhibit explosive burst fire as a first step of fire energy release from cell internal thermal runaway. To mitigate, prevent, and stop fire propagation from highly heating up and thermally damaging surrounding battery cells, it is often necessary or desirable to thermally isolate explosive burst fire quickly (such as at or near the beginning of a thermal runaway event) by guiding the explosive burst fire out of the battery module without the explosive burst fire continuing long enough to heat surrounding cells near the cell experiencing thermal runaway.

In this example, the cover 414 further includes a plurality of holes or apertures 426 disposed through the side plate 416. The apertures 426 are arranged so as to align with the vents of battery cells in order to guide explosive burst fire emitted from the vents through the apertures 426 and away from other battery cells. The apertures 426 allow for emissions to be guided out and away from the battery module quickly when thermal runaway occurs, without allowing the emissions to remain long enough to heat up surrounding cells. This, combined with the thermal barrier 412 insulating the battery cells and absorbing heat energy during thermal runaway and during an explosive burst fire event, mitigates the thermal runaway experienced by a battery cell and prevents fire propagation to other battery cells.

The thermal barrier 412 can be made of one or more materials with enough thermal resistance to mitigate and stop fire propagation, as well as insulate the sensitive cell vents, which are usually a mechanical weak point and a thin package material that could be easily melted and damaged from explosive burst fire. In some embodiments, the thermal barrier 412 can have a thermal conductivity from about 0.05 W/m*K to about 0.2 W/m*K. In addition, the thermal barrier 412 ideally will not melt from explosive burst fire from cell thermal runaway in order to provide thermal insulation for and protect surrounding cells. In some embodiments, the thermal barrier 412 can have a melting point above about 800° C. In various embodiments, the thermal barrier 412 is a soft and/or porous thermal barrier to facilitate air flow, have a mechanical tensile strength below about 150 kPa, and is made from materials such as ceramic wool or fabric (which may be formed using silicon oxide, calcium oxide, ceramic powder, glass wool, etc.) that provide high levels of thermal resistance to prevent thermal damage to battery cells without melting from fire caused by cell thermal runaway.

The thermal barrier 412 can be of varying thickness, where its thickness may vary depending on the amount of space between the battery cells and the cover 414. In some cases, the thermal barrier 412 may have a nominal thickness of about 3 mm. The variations in the thickness of the thermal barrier 412 can vary depending on various factors, such as the material of the thermal barrier 412 and/or the energy absorption needed by the thermal barrier 412.

Although FIGS. 4A-4D illustrate one example of a protective cover 414 and a thermal barrier 412, those skilled in the art will recognize that various changes may be made to the examples of FIGS. 4A-4D. For example, the cover 414 may be a singular component, rather than two separate components, formed or shaped to at least partially enclose or surround a battery module. Additionally, the overall structure of the thermal barrier 412 and/or the cover 414 may differ without departing from the scope of this disclosure, such as by altering the dimensions of the thermal barrier 412 and/or the cover 414 to account for different sizes or dimensions of a battery module, altering the arrangement of the apertures 426 so as to align with vents of battery cells, and so on.

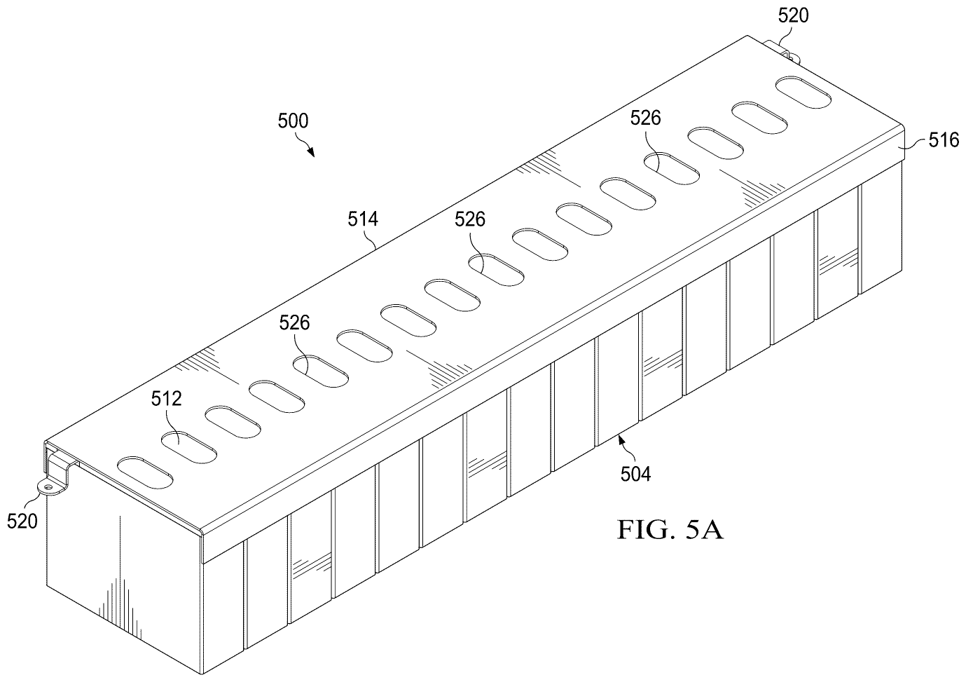

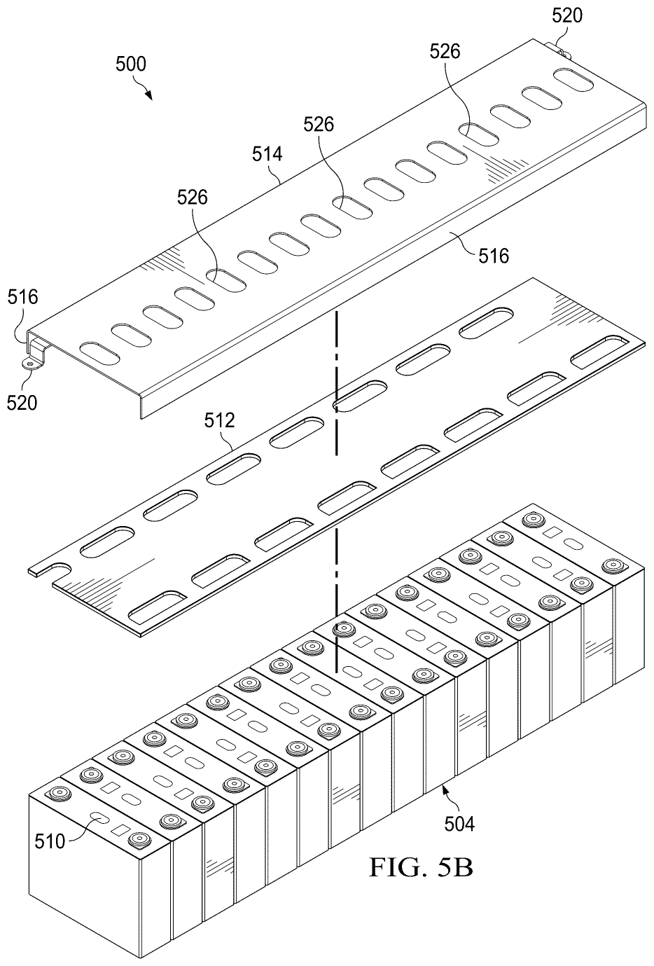

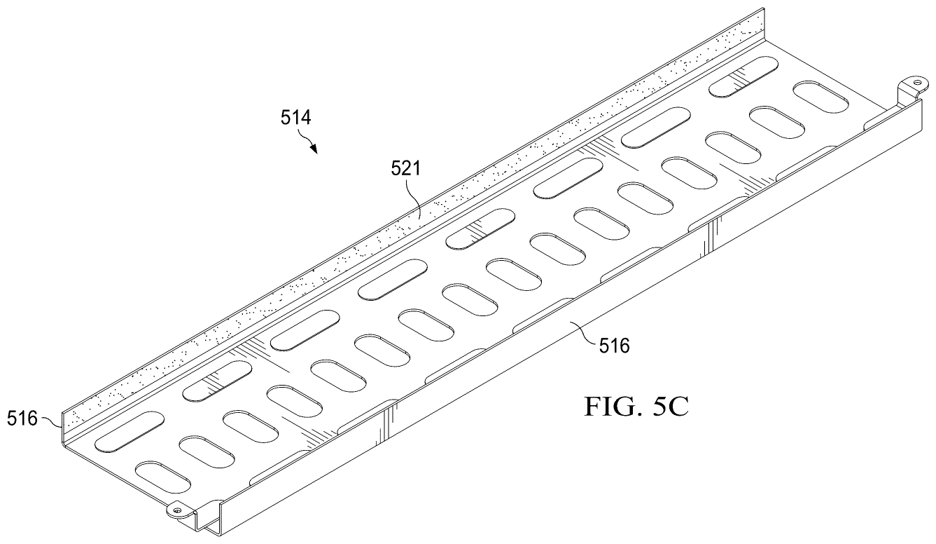

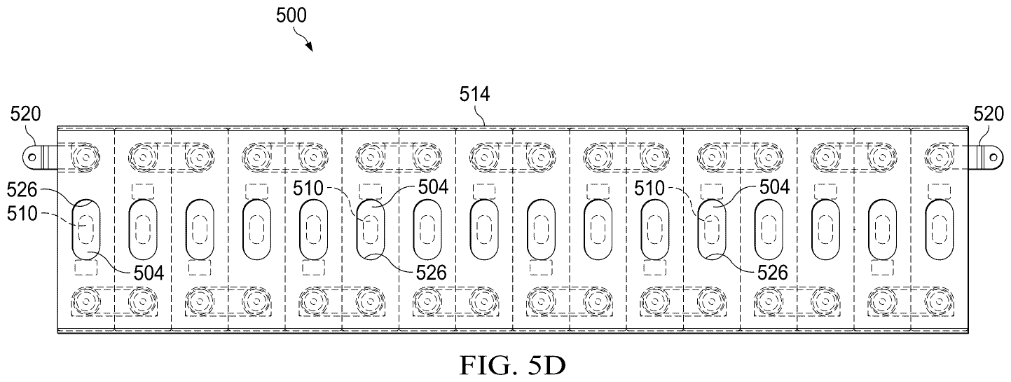

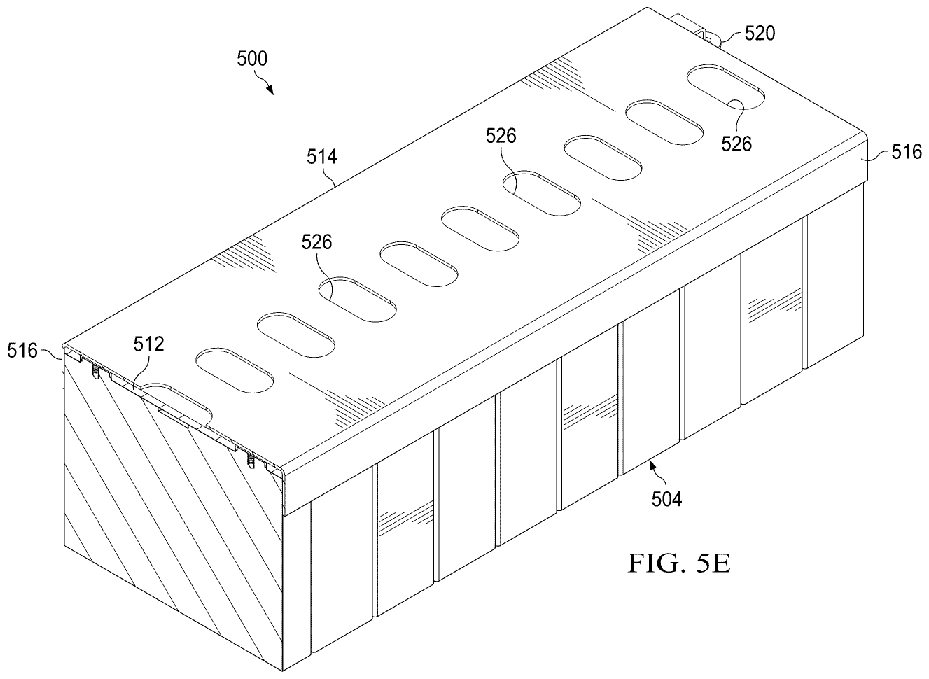

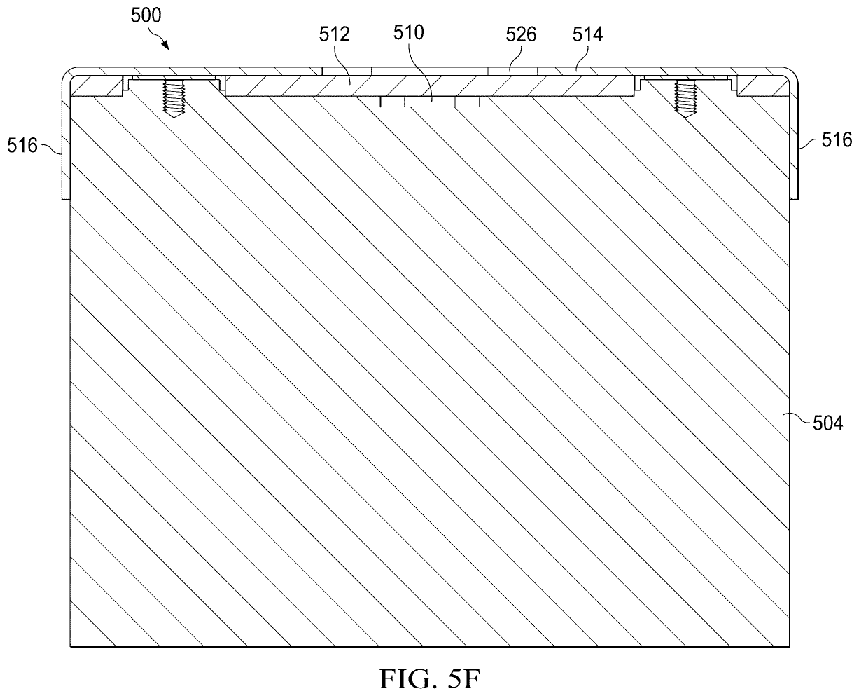

FIGS. 5A-5F illustrate additional details of an example battery module 500 in accordance with embodiments of this disclosure. More specifically, FIG. 5A illustrates the battery module 500 fully assembled, FIG. 5B illustrates an exploded view of the battery module 500, FIG. 5C illustrates a bottom view of a cover 514 of the battery module 500, FIG. 5D illustrates a side view of the battery module 500, FIG. 5E illustrates a perspective cross-sectional view of the battery module 500 showing an internal portion of the battery module 500, and FIG. 5F illustrates a front cross-sectional view of the battery module 500 showing an internal portion of the battery module 500.

As shown in FIGS. 5A-5F, the battery module 500 includes a plurality of lithium-ion battery cells 504, such as prismatic can battery cells. As shown in FIGS. 5A-5F (and in FIGS. 3A-3D described above), the covers and thermal barriers of this disclosure can have a variety of shapes, dimensions, and configurations depending (among other things) on the types of battery cells to be protected and/or the environment or structure in which the battery cells are stored. In some embodiments, the battery cells 504 illustrated in FIGS. 5A-5F can be stored in a housing, frame, or other structure. The battery cells 504 can be electrically coupled together to serve as at least a portion of a power source to an electric vehicle, such as the electric vehicle 100, or other powered device or system. In some embodiments, the battery module 500 can be installed within a framework for the electric vehicle 100, such as the framework 200.

In various embodiments of this disclosure, each battery cell 504 includes a vent 510 having a vent cap to allow for gas or burst fire emissions to exit the battery cell 504 when pressure reaches a preset threshold level. In some embodiments, the vent 510 can include a cap that is destroyed by gases or burst fire exiting the battery cell 504 through the vent upon pressure reaching the pressure threshold. In other embodiments, the cap can mechanically open and close, such as by using a vent valve, when pressure reaches the preset threshold level.

To prevent or mitigate fire propagation, the battery module 500 includes a thermal insulation barrier 512 placed against the battery cells 504 to protect the cells 504 from thermal runaway. The battery module 500 also includes a protective cover 514 to hold the thermal barrier 512 in the correct position. In some embodiments, the thermal barrier 512 can be disposed in, coupled to, or adhered within an interior portion of the protective cover 514. In some embodiments, the cover 514 can include two side plates 516 that extend a distance along sides of the battery cells 504 to prevent the cover 514 from moving. In some embodiments, the cover 514 can include one or more high voltage busbars for electrically connecting components. In various embodiments, the cover 514 can also be secured to battery cells 504, such as via an adhesive, such as an adhesive strip or patch 521 positioned along one or more of side plates 516, or via securing or fastening hardware.

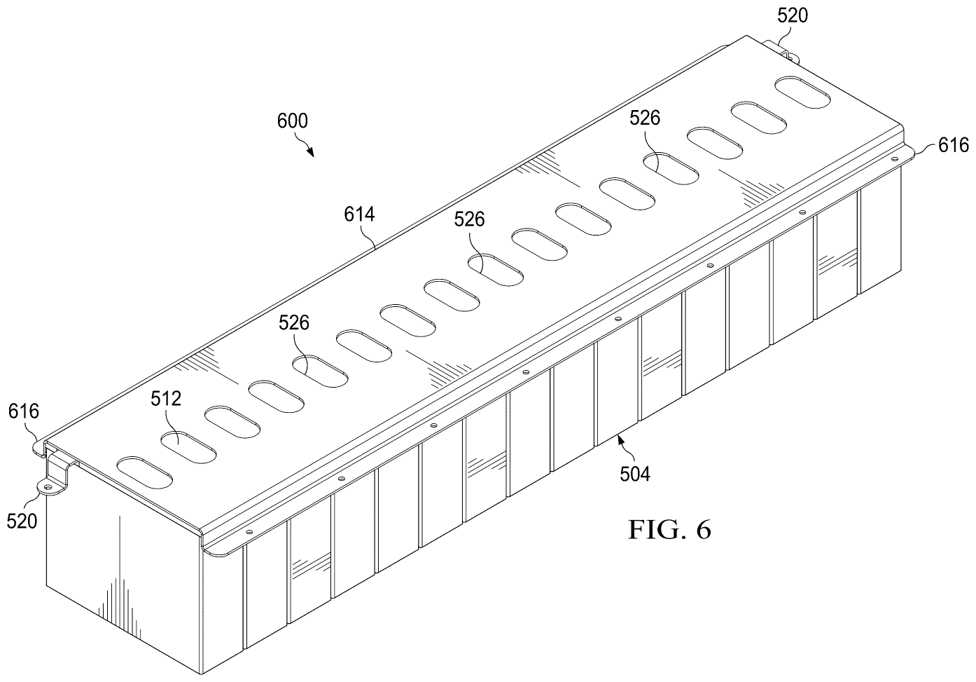

For example, as shown in FIG. 6, an example battery module 600 in accordance embodiments of this disclosure can include a cover 614 with side plates 616 that include a plurality of mounting holes or apertures. The mounting holes can, in various embodiments, be used to secure the battery module 600 to structures such as a module crossmember within a vehicle framework, such as framework 200, within an electric vehicle, such as vehicle 100. In some embodiments, the battery module 600 does not include an adhesive, such as adhesive strip 521, relying on just the mounting holes of the side plates 616 to secure the cover 614 over the battery cells 504. In some embodiments, the cover 614 can include both the mounting holes of the side plates 616 as well as an adhesive, such as adhesive strip 521.

The cover 514 can be made from various materials, plastic materials like plastic resin, plastic resin matrix reinforced by glass or carbon fiber or metallic materials like aluminum or steel or plastic-film coated metal or plastic resin molded metal metallic. Again, lithium-ion rechargeable cells have a rigid packaging, such as metal packaging or fiber-reinforced plastic resin wrapped metal packaging. Lithium-ion rechargeable cells in such a rigid packaging, including designated vents, exhibit explosive burst fire as a first step of fire energy release from cell internal thermal runaway. To mitigate, prevent, and stop fire propagation from highly heating up and thermally damaging surrounding battery cells, it is often necessary or desirable to thermally isolate explosive burst fire quickly (such as at or near the beginning of a thermal runaway event) by guiding the explosive burst fire out of the battery module without the explosive burst fire continuing long enough to heat surrounding cells near the cell experiencing thermal runaway. Here, the cover 514 further includes a plurality of holes or apertures 526 disposed through the cover 514. The apertures 526 are aligned with the vents 510 of the battery cells 504 in order to guide explosive burst fire emitted from the vents 510 through the apertures 526 and away from other battery cells 504. This, combined with the thermal barrier 512 insulating the battery cells 504 and absorbing heat energy during thermal runaway and during an explosive burst fire event, mitigates the thermal runaway experienced by a battery cell 504 and prevents fire propagation to other battery cells 504.

The thermal barriers 512 can be made of one or more materials with enough thermal resistance to mitigate and stop fire propagation, as well as insulate the sensitive cell vents 510, which are usually a mechanical weak point and a thin package material that could be easily melted and damaged from explosive burst fire. In some embodiments, the thermal barriers 512 can have a thermal conductivity from about 0.05 W/m*K to about 0.2 W/m*K. In addition, the thermal barriers 512 ideally will not melt from explosive burst fire from cell thermal runaway in order to provide thermal insulation for and protect surrounding cells 504.

In some embodiments, the thermal barriers 512 can have a melting point above about 800° C. In various embodiments, the thermal barriers 512 are soft and/or porous thermal barriers to facilitate air flow, have a mechanical tensile strength below about 150 kPa, and are made from materials such as ceramic wool or fabric (which may be formed using silicon oxide, calcium oxide, ceramic powder, glass wool, etc.) that provide high levels of thermal resistance to prevent thermal damage to cells 504 without melting from fire caused by cell thermal runaway.

Strong and rigid thermal barriers, such as high mechanical strength ceramic or glass wool or fabric, ceramic plate barriers, rock wool barriers, etc., can block explosive burst fire from being emitted quickly through the apertures 526, holding the explosive burst fire within the cover 514 and potentially damaging cells 504 and allowing fire propagation. The thermal barrier 512 can be of varying thickness, where its thickness may vary depending on the amount of space between the battery cells 504 and the cover 514. In some cases, the thermal barrier 512 may have a nominal thickness of about 3 mm. The variations in the thickness of the thermal barrier 512 can vary depending on various factors, such as the material of the thermal barriers 512 and/or the energy absorption needed by the thermal barriers 512.

Although FIGS. 5A-5F illustrate additional details of one example of a battery module 500, those skilled in the art will recognize that various changes may be made to the example of FIGS. 5A-5F. For example, the cover 514 may not include the side plates 516 and may only be held in place by the adhesive strip 521. Additionally, the overall structure of the battery module 500, the thermal barrier 512, and/or the cover 514 may differ without departing from the scope of this disclosure, such as by altering the dimensions of the battery module 500, the thermal barrier 512, and/or the cover 514, the number of battery cells, the arrangement of the battery cells, and so on.

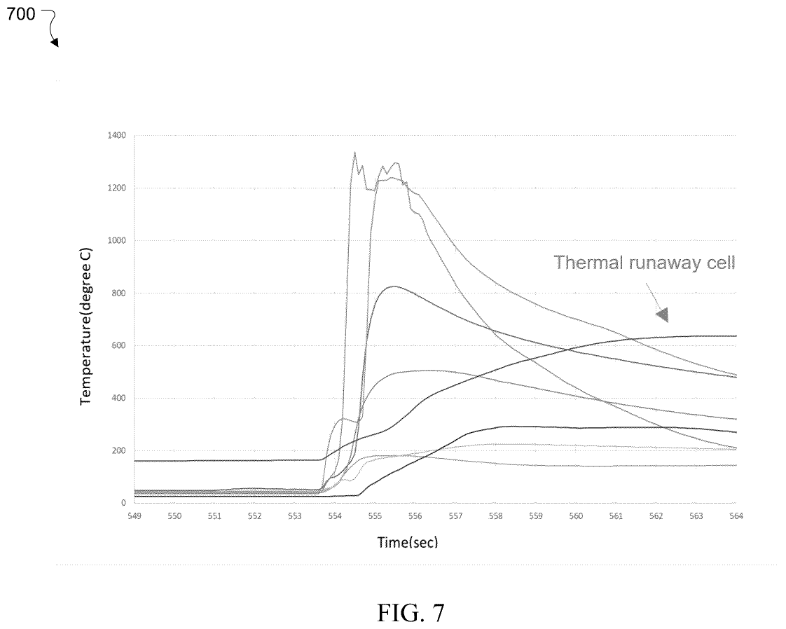

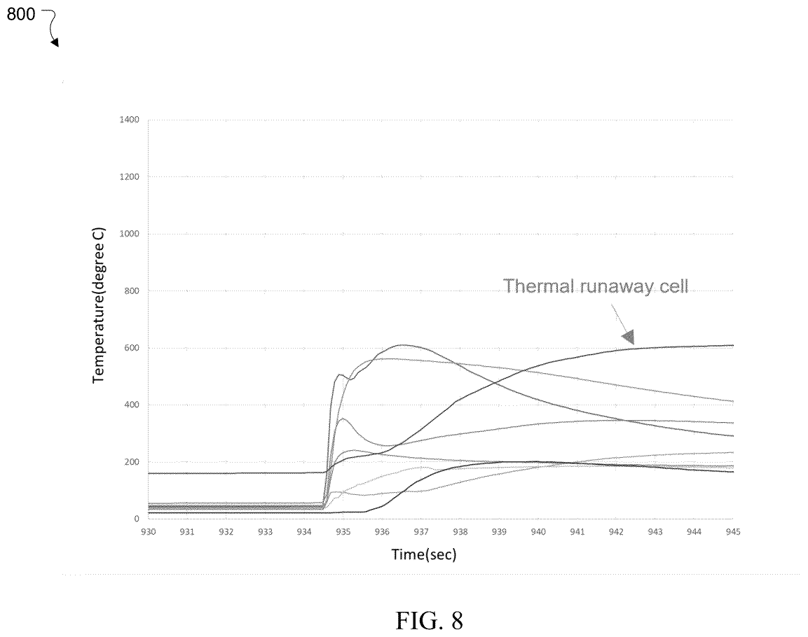

FIG. 7 illustrates an example chart 700 showing temperatures of a battery cell experiencing thermal runaway and temperatures of surrounding cells, where a battery module includes a rigid thermal barrier and/or where the battery module does not have a cover with apertures aligned with cell vents. FIG. 8 illustrates an example chart 800 showing temperatures of a battery cell experiencing thermal runaway, and temperatures of surrounding cells, where a battery module includes a soft thermal barrier and includes a cover with apertures aligned with cell vents in accordance with embodiments of this disclosure.

Due to explosive burst fire, surrounding battery cells' surface temperatures can increase to over approximately 1000° C. in a short time. As shown in FIG. 7, when a rigid thermal barrier is used and/or a battery module does not have a cover with apertures aligned with cell vents, a battery cell experiencing thermal runaway can cause temperatures of surrounding battery cells to rise close to or above 1000° C., even though its temperature has only reached 200° C. This can occur in as little as about 554 seconds in this example. This can cause fire propagation and/or damage to the surrounding battery cells.

As shown in FIG. 8, in accordance with embodiments of this disclosure, a soft thermal barrier and a protective cover with apertures aligned with cell vents are used. As a result, a battery cell experiencing thermal runaway takes longer to see temperatures rise above 200° C., such as over 900 seconds. Moreover, surrounding battery cells experience much lower temperatures, such as temperatures reaching only around 600° C. in this example. This is because, as described in the various embodiments of this disclosure, battery modules including soft thermal barriers and holes or apertures in a protective cover quickly guide and direct explosive burst fire emissions through the thermal barrier and through the of the protective cover apertures, which reduces or minimizes the amount of heat energy spread to surrounding battery cells.

Although FIGS. 7 and 8 illustrate examples of charts showing temperatures of battery cells experiencing thermal runaway and temperatures of surrounding cells in different scenarios, those skilled in the art will recognize that various changes may be made to the examples of FIGS. 7 and 8. For instance, the specific times, temperatures, and curves shown in FIGS. 7 and 8 are for illustration and explanation only and do not limit the scope of this disclosure.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A battery system comprising:
a cover including a plurality of guide apertures; and
a thermal barrier disposed adjacent the plurality of guide apertures of the cover;
wherein each one of the plurality of guide apertures is configured to guide emissions through the cover, and the thermal barrier is configured to absorb heat energy generated by the emissions.

2. The battery system of claim 1, further comprising:
a plurality of battery cells;
wherein the thermal barrier is disposed between the plurality of battery cells and the cover.

3. The battery system of claim 2, wherein each one of the plurality of battery cells comprises a vent configured to release the emissions.

4. The battery system of claim 3, wherein each of the plurality of guide apertures of the cover is aligned with the vent of one of the plurality of battery cells to guide emissions released by the vent through the cover.

5. The battery system of claim 3, further comprising:
a housing;
wherein the plurality of battery cells is arranged within the housing and the cover is coupled to the housing.

6. The battery system of claim 5, wherein:
the cover comprises side plates each coupled to the housing;
the side plates each comprise a portion of the plurality of guide apertures; and
the thermal barrier comprises two thermal barriers each disposed adjacent to one of the side plates.

7. The battery system of claim 6, wherein the plurality of battery cells is a plurality of cylindrical battery cells.

8. The battery system of claim 4, wherein the plurality of battery cells is a plurality of prismatic battery cells.

9. The battery system of claim 3, wherein the vent is configured to open in response to pressure reaching a preset threshold level.

10. The battery system of claim 1, wherein the thermal barrier has a tensile strength below 150 kPa.

11. An electric vehicle comprising:
at least one electric motor; and
a power supply configured to provide electrical energy to the at least one electric motor, the power supply including a battery module, the battery module comprising:
a cover including a plurality of guide apertures; and
a thermal barrier disposed adjacent the plurality of guide apertures of the cover;
wherein each one of the plurality of guide apertures is configured to guide emissions through the cover, and the thermal barrier is configured to absorb heat energy generated by the emissions.

12. The electric vehicle of claim 11, wherein:
the battery module further comprises a plurality of battery cells; and
the thermal barrier is disposed between the plurality of battery cells and the cover.

13. The electric vehicle of claim 12, wherein each one of the plurality of battery cells comprises a vent configured to release the emissions.

14. The electric vehicle of claim 13, wherein each of the plurality of guide apertures of the cover is aligned with the vent of one of the plurality of battery cells to guide emissions released by the vent through the cover.

13. The electric vehicle of claim 13, wherein:
the battery module further comprises a housing; and
the plurality of battery cells is arranged within the housing and the cover is coupled to the housing.

16. The electric vehicle of claim 15, wherein:
the cover comprises side plates each coupled to the housing;
the side plates each comprise a portion of the plurality of guide apertures; and
the thermal barrier comprises two thermal barriers each disposed adjacent to one of the side plates.

17. The electric vehicle of claim 16, wherein the plurality of battery cells is a plurality of cylindrical battery cells.

18. The electric vehicle of claim 14, wherein the plurality of battery cells is a plurality of prismatic battery cells.

19. The electric vehicle of claim 13, wherein the vent is configured to open in response to pressure reaching a preset threshold level.

11. The electric vehicle of claim 11, wherein the thermal barrier has a tensile strength below 150 kPa.
